(19) United States
(12) Patent Application Publication
(10) Pub. No.: US 2007/0209038 A1
(43) Pub. Date: Sep. 6, 2007

(54) Conflict avoidance and resolution in a distributed computing system

(76) Inventors: Carsten Fuchs, Wiesloch (DE); Hans-Ulrich Von Helmolt, Heldelberg (DE); Martin Semmler, Angelbachtal (DE)

Correspondence Address: FISH & RICHARDSON, P.C., PO BOX 1022, MINNEAPOLIS, MN, 55440-1022, US

(21) Appl. No.: 11/352,634

(22) Filed: Feb. 13, 2006

(51) Int. Cl. G06F 9/46

(52) U.S. Cl. 719/313

(57) ABSTRACT

Conflict avoidance and conflict detection and resolution methods are provided for transaction processing in a distributed computing system. For conflict avoidance, first data for a transaction is generated in a first computing system and is used in executing a dependent process for the transaction in a second computing system that is integrated with the first computing system by an asynchronous messaging system. The first data is sent to the second computing system in a first asynchronous message. The first computing system receives from the second computing system a second asynchronous message with second data that identifies when a predefined event of the transaction, dependent on the first data, is to occur. User alteration of the first data for the transaction in the first computing system is then prevented after a preconfigured time period before when the predefined event is identified to occur.

### TECHNICAL FIELD

This invention relates to transaction processing in a distributed computing system that uses asynchronous messaging.

### BACKGROUND

Distributed enterprise computing systems may be made up of several, separate computing systems operating independent of each other and linked by an asynchronous messaging framework. The messages sent between the separate computing systems may be exchanged, for example, using a messaging system that resides in middleware, and the messaging system may use store-and-forward message transfer techniques. Using store-and-forward message transfer techniques, it is possible, for example, to control the timing of message transfer traffic to conserve overall bandwidth, for example, non-critical messages may only be forwarded during times, in the middle of the night for example, when message traffic would be minimal. The separate computing system so coupled by the asynchronous messaging system are often referred to as being “loosely coupled” systems. A “loosely coupled” architecture is often seen as having an advantage of making integration and scalability easier to accomplish.

A transaction computing process may involve more than one of the “loosely coupled” computing systems of such a distributed enterprise computing system. For example, a product sales transaction process may involve a sales order application module operating on a first system, and a delivery application module operating on a separate, second system. The sales order application module may create, for example, a sales order that includes data such as customer information, purchased product information, delivery terms, etc. The delivery application may receive information from the first system for a particular sales order and perform processing to fulfill the sales order as requested. As such, the first system with the sales order application module needs to transfer to the second system the necessary information to accomplish order fulfillment by way of the asynchronous messaging framework.

As is often the case with sales order transactions, a customer may wish to change or even cancel an order after having made the order. In addition, the delivery application module may determine that a sales order cannot be fulfilled as requested, for example, because requested delivery times cannot be met or because product is not immediately available. As such, there is the possibility for conflicting information relating to the same sales transaction being resident on the two different systems.

### SUMMARY

Generally, this document describes techniques for avoiding data conflicts within separate computing systems in a distributed computing system that uses an asynchronous messaging framework, and also describes techniques for resolving conflicts within such separate computing systems.

In one aspect, a computer-implemented conflict avoidance method is provided for transaction processing in a distributed computing system. The method includes generating, in a first computing system, first data for a transaction. The first data is used in executing a dependent process for the transaction in a second computing system that is integrated with the first computing system by an asynchronous messaging system. The method also includes sending the first data from the first computing system to the second computing system in a first asynchronous message. The method further includes receiving, in the first computing system, a second asynchronous message with second data, provided by the second computing system. The second data identifies when a predefined event of the transaction is to occur. The predefined event is dependent on the first data. The method also includes preventing user alteration of the first data for the transaction in the first computing system after a preconfigured time period before when the predefined event is identified to occur.

In various implementations, the computer-implemented method may include one or more of the following features. The transaction may be a sales order transaction, in which case the first computing system may include a sales order generating module, and the first data may be sales order information that is included in an electronic document that is transmitted in the first asynchronous message. In this case, the second computing system may include a sales order logistics application module that produces a delivery order for a sales order transaction. The delivery order may be generated automatically from the sales order information transmitted in the first asynchronous message. The predefined event, in this example, may be a specified point in a delivery process.

In addition, the user alteration in the method may be prevented by an error message appearing on a user display device upon attempted user alteration of the first data. Additionally or alternatively, the user alteration may be prevented by data entry fields presented on a display device being indicated to show that the user alteration of the first data is not allowed. The selected time used in the method may be configurable by a user for a class of transactions, or may be configurable by a user for each transaction.

In anther aspect, a computer-implemented conflict detection and resolution method is provided for transaction processing in a distributed computing system. The method includes receiving first data for a transaction, wherein the first data is generated in a first computing system and is used in executing a dependent process for the transaction in a second computing system that is integrated with the first computing system by an asynchronous messaging system. The first data being is in the second computing system in a first asynchronous message. The method also includes receiving, in the second computing system, a second asynchronous message altering the first data, wherein the altering of the first data was performed in the first computing system after a selected time before a predefined event of the transaction is to occur. The predefined event is dependent on the first data. The method also includes determining whether or not the predefined event has occurred, and if so, rejecting the altered first data, and if not, accepting the altered first data.

In various implementations, the computer-implemented method may include one or more of the following features. The first computing system may include a sales order generating module, and first data may be sales order information that is included in an electronic document that is transmitted in the first asynchronous message. In this case, the second computing system may include a sales order logistics application module that produces a delivery order for a sales order transaction. In the method, if the altered first data is rejected, the method may also include sending from the second computing system and to the first computing system an asynchronous message that indicates the altered data has been rejected. In such a case, upon receipt in the first system of the asynchronous message that indicates the altered data has been rejected, allowing reversal of the alterations to the first data in the first computing system.

Both the conflict avoidance and conflict detection and resolution methods may be implemented in the same system, and may serve as complementary tools for providing an overall conflict avoidance and resolution methodology for a distributed computing system that uses asynchronous messaging.

In other aspect, computer program products are provided so that the above-described computer-implemented methods may be performed. The computer program products include instructions that when executed, for example by a processor, perform operations of the methods described above.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary distributed computing system in which conflict avoidance and resolution techniques are employed.

FIG. 2 is a block diagram of an exemplary system of the type shown in FIG. 1.

FIGS. 3A-3B are flow charts showing exemplary steps for implementing a conflict avoidance method in the system of FIG. 2.

FIG. 4 is a flow chart showing exemplary steps for implementing a conflict resolution method in the system of FIG. 2.

FIG. 5 is a schematic diagram of a generic computer system.

Like reference symbols in the various drawings indicate like elements.

### DETAILED DESCRIPTION

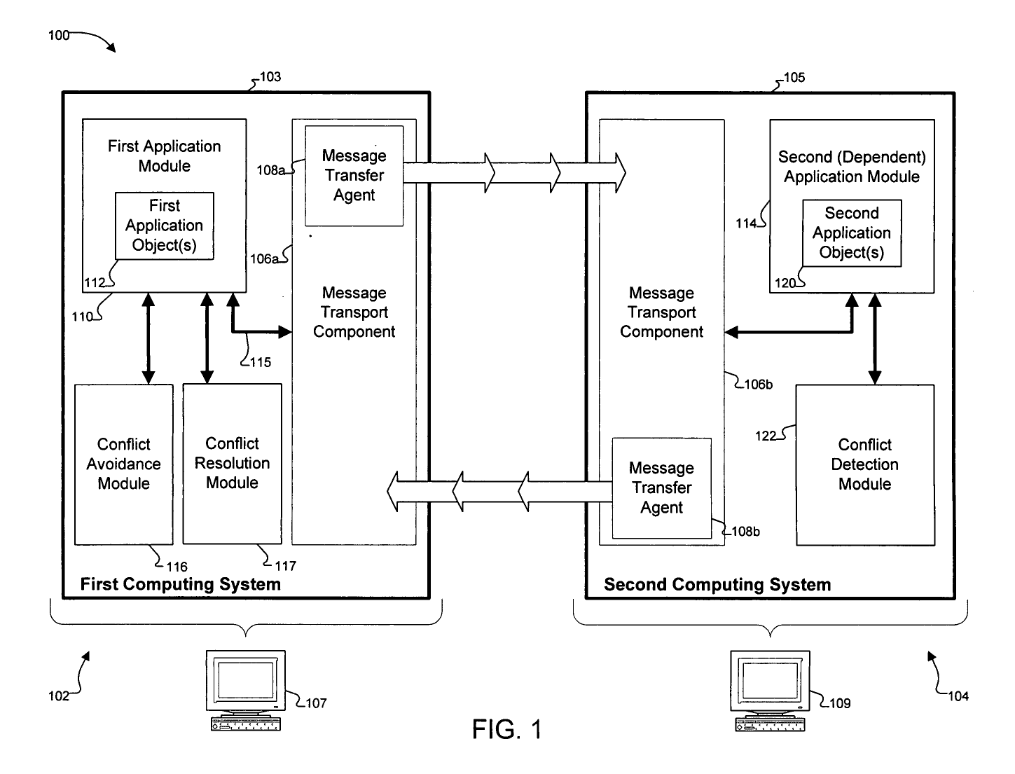

A distributed computing system 100, shown in FIG. 1, includes two networked computer systems, which in this example are a first computing system 102 and a second computing system 104. Messages containing a current status of an object or document are transferred asynchronously from the first computing system 102 and eventually to the second computing system 104 by way of respective message transport components 106a and 106b, as is depicted in FIG. 1. Provision of an asynchronous messaging layer allows components in a distributed system to be modified or updated without creating unanticipated changes within other components. The messages are exchanged between the two systems using respective message transfer agents 108a and 108b. The exemplary system 100 shows conflict modules 116, 117 and 122 on both computing systems used to avoid or resolve any messaging or data issues that may arise between the two computing systems.

The first computing system 102 includes server-side equipment 103, on which a first server-based application module 110 resides. Execution of the first application module 110 causes the creation and revision of first application objects 112. The first application module 110 may, for example, accept input from a user or from some other external computing process. The first computing system 102 typically includes client devices for users, and in the FIG. 1 example, one such client device 107 is shown for simplicity. The client device 107 may be a desktop computer or a mobile computing system such as a laptop, for example.

The second computing system 104 similarly has server-side equipment 105 on which a second server-based application module 114 resides. Execution of the second application module 114 causes the creation and revision of second application objects 120. The second application module 114 may, for example, accept input from a user or from some other external computing process such as first application module 110. The second application module 114 is labeled in FIG. 1 as “dependent” because it executes a process dependent upon receiving information from the first computing system 102 that was produced during execution of the first application module 110. The second computing system 104 may similarly have various client devices, and one such device 109 is shown in FIG. 1.

Execution of the first application module 110 creates objects 112, and creates documents of object information for transport in the asynchronous messaging system to the second computing system 104. For example, the first application module 110 may be for entering purchase orders, in which a sales agent enters orders while talking to a customer on a telephone. In this example, the sales agent would create a purchase order document in the software application, from which the application module 110 may further create sales order objects containing attributes about the order. This object information may then be used to create an electronic document suitable for transfer into the asynchronous messaging system to be transported to the second computing system 104 capable of handling the order and delivery process.

The message transport components 106a and 106b are part of the previously mentioned messaging system for the distributed computing system 100. Information, such as the first application object 112 that needs to be forwarded to another system, first is forwarded, or “posted,” by the first application module 110 to the message transport component 106a. This is illustrated in FIG. 1 by the arrow 115 from the first application module 110 to the message transport component 106a. Each message transport component 106a and 106b contains its own respective message transfer agent 108a and 108b. The message transfer agent 108a controls the forwarding of messages from the first application module 112 and serves as a central messaging center for the entire distributed computing system 100.

In the FIG. 1 example, it is shown that the messages from the first application module 110 are forwarded first to the message transport component 106a en route to the second computing system 104 through the message transfer agent 108a. This is an example of how a message may be routed to another system. Both message transfer agents 108a and 108b may contain, for example, routing or mapping software applications, as well as additional layers to accommodate messaging in the system 100. Exemplary application software could have routing logic to determine where a received message is to be forwarded and a mapping logic to perform translation steps. For example, if the data format used by the second computing system 104 differs from that used by the first computing system 102, then the application software may translate the format for a received message into a format that can be understood by second computing system 104.

The information included in the message may be the first application object 112 itself, may be a document including only selected data obtained from a first application object, or may be yet another document or object derived from, or calculated from information in a first application object 112. For example, an electronic document such as an extensible Markup Language (XML) type document may be created by the first computing system 102, which would send the XML document to the second computing system 104. The second computing system 104 would then use the information in the received XML document to create a second application object 120.

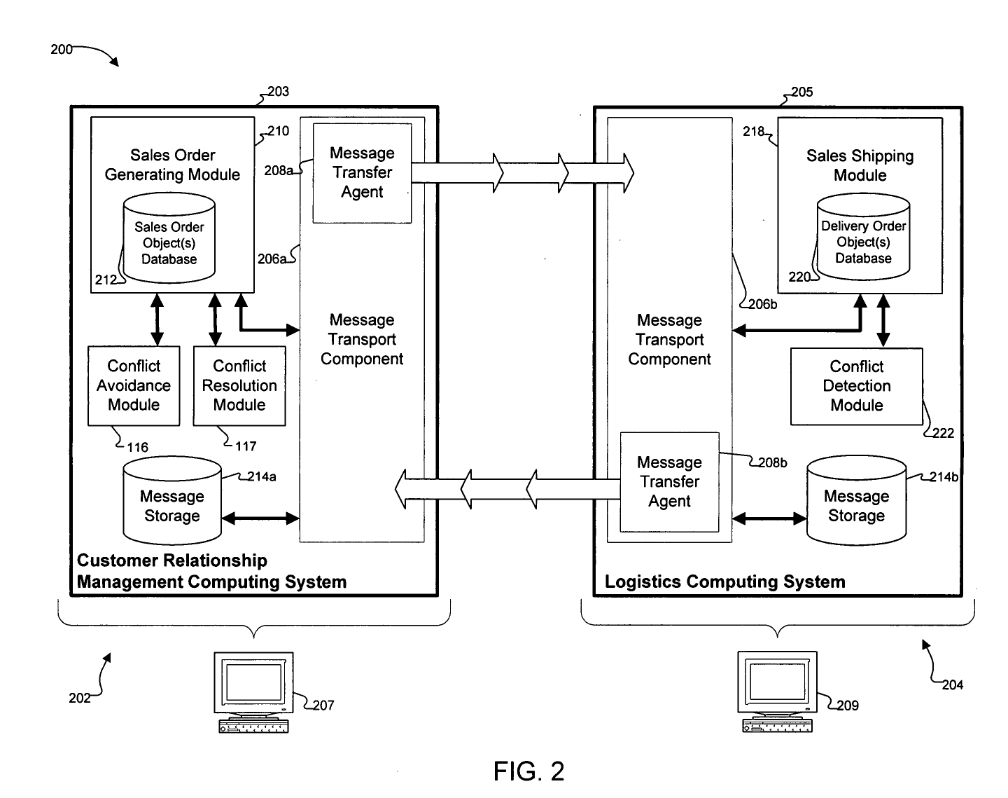

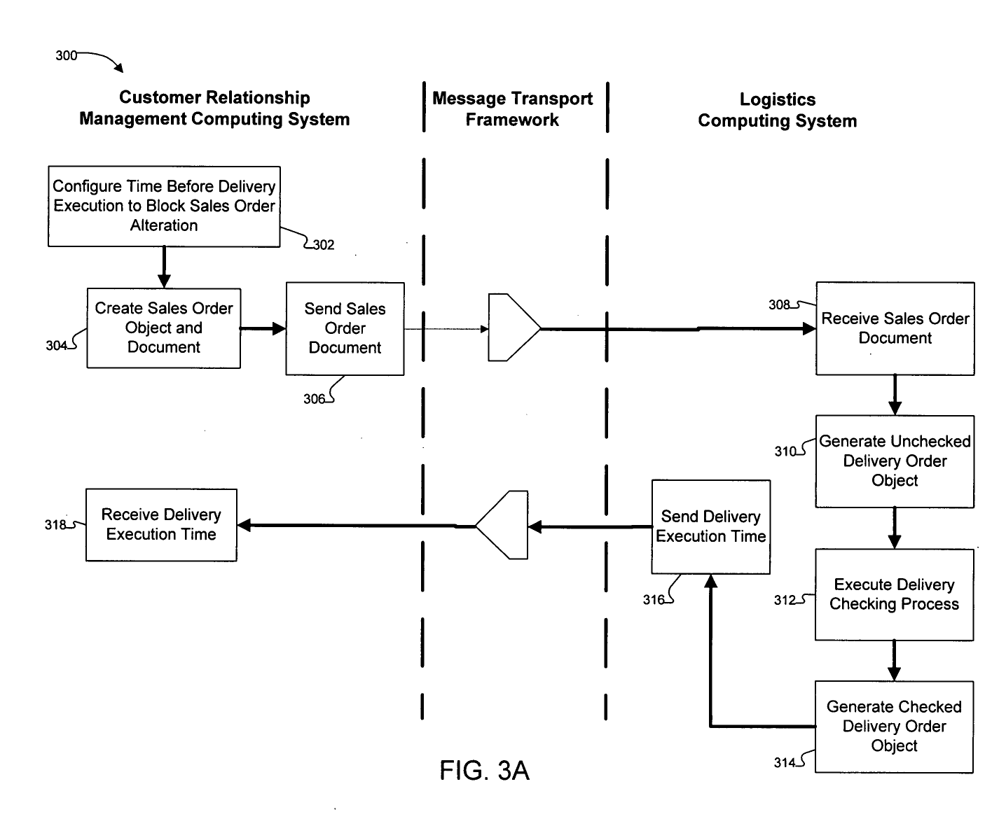

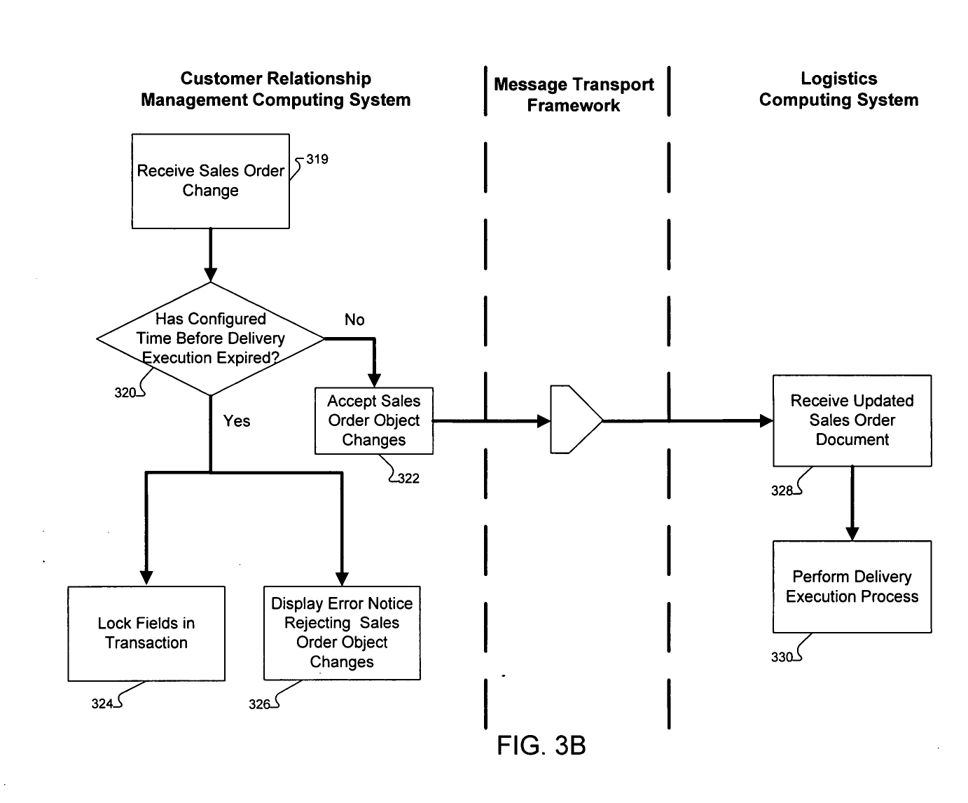

The conflict avoidance module 116 shown in FIG. 1 serves to prevent alteration of first application objects 112 by a user in the first computing system 102 when doing so would create, or potentially create, an inconsistency with corresponding second application objects 120. The prevention of altering the first objects 112 may be dependent upon system rules that may be implemented. The conflict avoidance module 116 may be accessed from, or called from the first application module 110, and can provide data back to the first application module 110. The conflict avoidance module 116 will be covered in detail in the FIG. 2 and 3A-B descriptions.

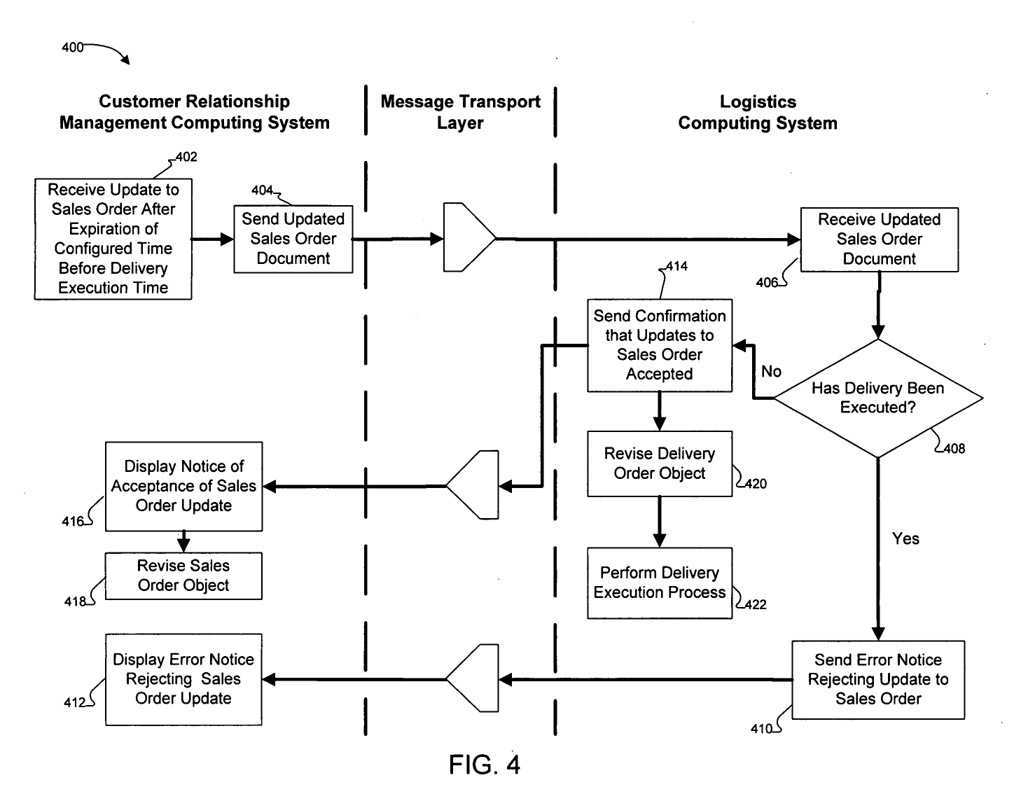

The conflict detection module 122 in the second computing system 104 similarly functions to maintain consistency between first application objects 112 and second application objects 120. The conflict detection module 122 may be accessed from, or called from, the second application module 114, and this module 122 serves to determine whether a proposed change from the first computing system 102 can be made that impacts a second application object 120. For example, suppose changes to a first application object are proposed which impact a corresponding second application object, and the changes are proposed despite the conflict avoidance module 116 rules implemented in the first computing system 102. The conflict detection module 122 detects if the proposed changes would pose an actual conflict. If so, the conflict detection module 122 rejects the changes (though that may be overridden as will be described later), will inform the first computing system 102 of the rejection. If not, the conflict detection module 122 accepts the changes, and will inform the first computing system 102 of the acceptance. As such, the applicable first and dependent second application objects will be changed accordingly and kept consistent. The conflict detection module 122 will be covered in detail in the FIG. 2 and 4 descriptions.

The conflict resolution module 117 in the first computing system 102 functions to resolve conflicts that are either created by an overriding of the conflict avoidance module 116 of the first computing system 102 or detected by the conflict detection module 122 of the second computing system 104. The conflict resolution module will be covered in detail in FIG. 2 and 4 descriptions.

FIG. 2 is a block diagram of an exemplary system of the general type shown in FIG. 1, and in which the previously mentioned conflict avoidance and resolution techniques are employed. Two networked computer systems are shown, which in this example are a customer relationship management (CRM) computing system 202 and a logistics computing system 204. The CRM computing system 202 generally includes all aspects of interaction a company may have with its customers, whether it be sales, marketing or service related. A logistics computing system 204 manages the procurement, movement and storage of materials, parts, and finished inventory (and the related information messages) through an organization in order to fulfill orders. Messages or documents relating to application objects are transferred asynchronously from the CRM computing system 202 to the logistics computing system 204. The messages are exchanged using respective message transfer agents 208a and 208b. The exemplary system 200 shows conflict modules 216 and 222 on both computing systems used to properly avoid or resolve any messaging issues that may arise between the two computing systems. Message storage repositories 214a and 214b are shown on both server systems to store transferred or received messages in.

The CRM computing system 202 includes server-side equipment 203, on which a server-based sales order generating module 210 resides. Generation of, or modifications to, a sales order causes the creation or revision of sales order objects in an electronic database 212. The CRM computing system 202 may be, for example, a computer system having an application thereon, which may accept input from a user. As such, the CRM computing system 202 may be a mobile computing system such as a handheld computer, a desktop computer or other application-bearing wireless device. The CRM computing system 202 may also be, for example, a computer system with a call center software application thereon, in which a sales agent enters sales orders while talking to a customer on the telephone.

The logistics computing system 204 similarly has server-side equipment 205 on which a server-based sales shipping module 218 resides. The sales shipping module 218 receives and processes sales order documents or sales order objects to fulfill and execute a sales order. Similar to the exemplary system of FIG. 1, the sales shipping module 218 is “dependent” because it executes a process dependent upon receiving information from the CRM computing system 202 that was produced during execution of the sales order generating module 210. Alternately, the sales shipping module 218 in the system 204 may receive from the CRM system 202 only the delivery information for a sales order object, and may process that information to effect delivery.

The system 200 in the FIG. 2 example includes message transport components 206a, 206b and message transferring agents 208a, 208b, which both work similar to the asynchronous messaging system described in FIG. 1. The message storage repository 214a may be queues or the like for messages that are awaiting transport. The message transport components 206a, 206b on both computing systems may access their respective message storage repositories, 214a and 214b, in the system 200. Information transferred across the message transport layer is forwarded in a message. The information included in the message may be a sales order object itself, may be a document, such as an XML document, including only selected data from a sales order object, or may be yet another document or object derived from, or calculated from, a sales order object.

The system 200 includes a conflict avoidance module 216 and a conflict resolution module 217 that function similar to the conflict avoidance module 116 and the conflict resolution module 117 shown in FIG. 1 and previously described briefly. In addition, the logistics computing system 204 also includes a conflict detection module 222 that functions similar to the conflict detection module 122 shown in FIG. 1 and also previously described briefly. The functioning of these modules 216, 217, and 222 will be described in connection with FIGS. 3A, 3B, and 4.

Referring to FIGS. 3A and 3B, flow charts are shown that depict exemplary steps for implementing a conflict avoidance method in the system of FIG. 2. The flow charts involve functions performed both on the CRM computing system 202 (shown on the left side of the flow charts) and on the logistics computing system 204 (shown on the right side of the flow chart). Briefly, FIG. 3A shows steps carried out to create objects or documents, and FIG. 3B shows steps to check for system conflicts when a document modification is requested. In FIG. 3A, the conflict avoidance method 300 begins, at step 302, with a user, for example, making use of the conflict avoidance module 216 to configure a rule for the conflict avoidance module 216 to use, which in the FIGS. 3A-3B example is the setting of a specific amount of time before delivery is scheduled to be executed.

In one implementation, the specific amount of time may be determined during a scheduling process which is performed as part of a computing process that checks the availability of product included in a sales order, for example. The amount of time may be determined depending on variable parameters, such as for example, an order type, a delivery priority, or customer group. In addition, the system may be configurable so that a user may configure the system to consider any number of predefined variable parameters that will be used in determining the specific amount of time during run time of the processing of a particular sales order. An administrator or some other user may configure the system to use the parameters that suit the particular needs of the process flow for fulfillment of orders.

Delivery execution, which may serve as a point in time from which the determined amount of time is measured, can be defined in the system 200 as the beginning of fulfilling a sales order for delivery, for example, physically picking products from an inventory warehouse. In the example of a sales order generating module 210, the purpose of this time is to prevent users from altering sales order objects after the configured time. The configuration step 302 need not be performed for every sales order subsequently created, but rather can be configured once for all sales orders.

Next, during normal run-time of the sales order generating module 210, a sales order object and a corresponding sales order document can both be created, in step 304, by the CRM computing system 202. For example, a user may enter information, which would create instances or objects, for the sales order, or the CRM system 202 may otherwise receive electronic information that causes the sales order to be created. The sales order object may include fields such as product identifiers, quantities, customer names (which may be referred to as a business partner), requested delivery date and modes of delivery, ship-to address, etc. After creation of an object and document suitable for transport to the logistics computing system 204, the system 202 sends at step 306, the sales order document to the logistics computing system 204 by way of the asynchronous message transport layer.

Upon receipt of the sales order document, in step 308, the logistics computing system 204 can generate an unchecked delivery order object in step 310. An unchecked delivery order object is an object that includes delivery terms and information included in the information received from the CRM system 202. The delivery order object may be said to be “unchecked” at this point because the sales shipping module 218 has not yet executed a process to check that the requested delivery terms can indeed be fulfilled. An unchecked delivery order can be converted to a delivery order with a document status of checked, in step 312, by executing the delivery checking process. The delivery checking process may include for example, an automated process that involves the checking of inventory and delivery resources to determine when and how each of several unchecked delivery orders is to be fulfilled. This process also includes the generation of an estimated or expected delivery execution time for each of the delivery orders. The logistics computing system 204 executes the process in step 312 and, in step 314, generates a checked delivery order object. At step 316, the logistics computing system 204 sends back to the CRM system 202 the delivery execution time for a delivery order corresponding to a specific sales order object in the CRM system 202. The delivery execution time is sent from the logistics computing system 204 to the CRM computing system 202 using the asynchronous message transport layer. The CRM computing system 202 receives the delivery execution time in step 318.

Referring now to FIG. 3B, a change in the sales order is received at step 319, and thereafter a check is made to determine if the change poses a conflict. A check for a system conflict begins at step 320, with an inquiry by the CRM computing system 202, and in particular the conflict avoidance module 216, of whether the configured time (from step 302) before delivery execution time (received at step 318) has expired. If the determined time has expired, the system 202 may lock user interface input data fields in this specific transaction, in step 324 so that changes to a sales order object can no longer be made. Alternatively, upon receipt of proposed changes to a sales order object, there may be a display of an error notice rejecting changes to the sales order object, in step 326. Alternatively, the system 202 may also perform both steps 324 and 326. On the other hand, if it is determined in step 320 that the configured time before delivery has not expired, changes to the sales order object may be accepted, in step 322. If changes are accepted, the sales order object is revised accordingly, and an updated sales order object (or document derived from the object) is sent by way of the message transport layer and received at the logistics computing system 204 in step 328. Eventually, the logistics system 204 performs the delivery execution process in step 330 according to the updated sales order information.

Referring now to FIG. 4, a flow chart is shown that depicts exemplary steps for implementing a conflict resolution method in the system of FIG. 2. In this case, the CRM computing system 202 receives an update to a sales order in step 402, and this occurs after the expiration of the previously configured allowable time for presenting updates to the system. This may occur, for example where a user in some manner, overrides the data entry block (see steps 324 and 326 in FIG. 3B) created by the conflict avoidance module 216. As mentioned previously, the delivery execution time for a sales/delivery order determined by the logistics computing system 204 may be an estimate of the delivery execution time, and it may still be possible to alter a sales order that has impacts on delivery execution even though a configured time before a planned delivery execution time has expired.

Upon receipt of an update to a sales order at step 402, the CRM computing system 202, and specifically the conflict resolution module 217, sends, at step 404, by way of the message transport layer, an updated sales order document to the logistics computing system 204, which receives the updated document in step 406. The updated document may include all of the information previously sent in step 306, or it may include only the proposed changes. The updated document may then be processed by the logistics computing system 204 to determine whether proposed changes will be allowed. The analysis begins, in step 408, with the logistics computing system 204, and specifically the conflict detection module 222, determining if delivery (or a specified delivery task) has actually been executed. This may involve input being obtained from a user via the client device 209, for example. It may also, or alternatively, involve a check of whether a confirmation input has been received by the logistics system 204 that delivery, or a specific task of a delivery process, has been executed. For example, the conflict detection module 222 may perform a comparison operation between a system defined time and a time when a change is submitted.

If it is determined in step 408 that delivery (or a specified delivery task) has been executed, the system 202 sends across the message transport layer, at step 410, an error notice message to the CRM system 202 and specifically the conflict resolution module 217, rejecting the proposed updates to the sales order. Additionally, a notice may be sent to an administrative party as a notice of an update to the system or a notice of attempted update to the system. The CRM computing system 202 receives the error notice message and displays it to a user, in step 412.

If, on the other hand, it is determined at step 408 that delivery has not yet been executed, the logistics system 204 accepts the proposed changes and hence updates the delivery order object. In addition, the logistics system 204 also, at step 414, sends to the CRM computing system 202, and specifically the conflict resolution module 217, a confirmation that the proposed changes have been accepted. The CRM computing system 202 receives the confirmation and displays a notice of acceptance to the user in step 416, and also revises the sales order object accordingly at step 418. After the confirmation of the changes being accepted is sent to the CRM system at step 414, the logistics system 204 revises the applicable delivery order object, at step 420, and eventually, at step 422, the delivery execution process is performed using the revised delivery order object.

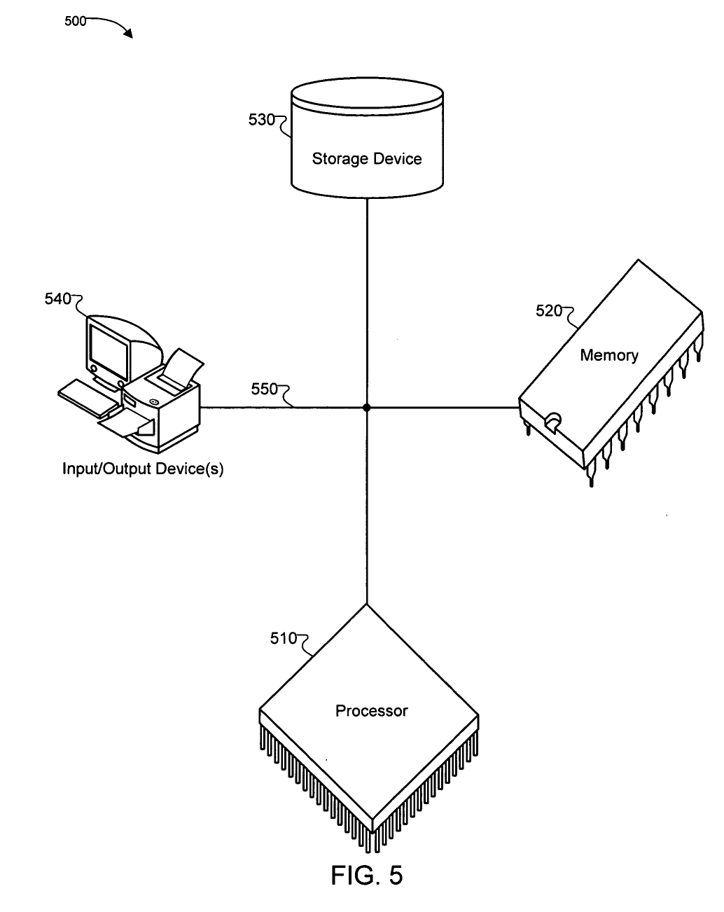

FIG. 5 is a schematic diagram of a generic computer system 500. The system 500 can be used for the operations described in association with method 300A, 300B, and 400 according to one implementation. For example, the system 500 may be included in either or all of the first computing system 102, the second computing system 104, the client devices 107, 109, 207 and 209, the customer relationship management computing system 202 and the logistics computing system 204.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500.

In one implementation, the storage device 530 is a computer-readable medium. In various different implementations, the storage device 530 may be a floppy disk device, a hard disk device, an optical disk device, or a tape device.

The input/output device 540 provides input/output operations for the system 500.

In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Also, the logic flows depicted in the figures do not require the particular order shown, or sequential order, to achieve desirable results. Also, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for transaction processing in a distributed computing system, the method comprising:
generating, in a first computing system, first data for a transaction, wherein the first data is used in executing a dependent process for the transaction inma second computing system that is integrated with the first computing system by an asynchronous messaging system, and sending the first data from the first computing system to the second computing system in a first asynchronous message;
receiving, in the first computing system, a second asynchronous message with second data, provided by the second computing system, that identifies when a predefined event of the transaction is to occur, the predefined event being dependent on the first data; and
preventing user alteration of the first data for the transaction in the first computing system after a preconfigured time period before when the predefined event is identified to occur.

2. The computer-implemented method of claim 1, wherein the transaction is a sales order transaction.

3. The computer-implemented method of claim 2, wherein the first computing system includes a sales order generating module, and wherein the first data is sales order information that is included in an electronic document that is transmitted in the first asynchronous message.

4. The computer-implemented method of claim 3, wherein the second computing system includes a sales order logistics application module that produces a delivery order for a sales order transaction.

5. The computer-implemented method of claim 4, wherein the delivery order is generated automatically from the sales order information transmitted in the first asynchronous message.

6. The computer-implemented method of claim 4, wherein the predefined event is a specified point in a delivery process.

7. The computer-implemented method of claim 1, wherein the user alteration is prevented by an error message appearing on a user display device upon attempted user alteration of the first data.

8. The computer-implemented method of claim 1, wherein the user alteration is prevented by data entry fields presented on a display device being indicated to show that the user alteration of the first data is not allowed.

9. The computer-implemented method of claim 1, wherein the selected time is configurable by a user for a class of transactions.

10. The computer-implemented method of claim 1, wherein the selected time is configurable by a user for each transaction.

11. A computer program product tangibly embodied on an information carrier and comprising executable instructions that when executed perform a computer-implemented method for transaction processing in a distributed computing system, wherein the method comprises:
generating, in a first computing system, first data for a transaction, wherein the first data is used in executing a dependent process for the transaction in a second computing system that is integrated with the first computing system by an asynchronous messaging system, and that sends the first data from the first computing system to the second computing system in a first asynchronous message;
receiving, in the first computing system, a second asynchronous message with second data, provided by the second computing system, that identifies when a predefined event of the transaction is to occur, the predefined event being dependent on the first data; and
preventing user alteration of the first data for the transaction in the first computing system after a preconfigured time period before when the predefined event is identified to occur.

12. The computer program product of claim 11, wherein the transaction is a sales order transaction.

13. The computer program product of claim 12, wherein the first computing system includes a sales order generating module, and wherein the first data is sales order information that is included in an electronic document that is transmitted in the first asynchronous message.

14. The computer program product of claim 13, wherein the second computing system includes a sales order logistics application module that produces a delivery order for a sales order transaction.

15. A computer-implemented method for transaction processing in a distributed computing system, the method comprising:
receiving first data for a transaction, wherein the first data is generated in a first computing system and is used in executing a dependent process for the transaction in a second computing system that is integrated with the first computing system by an asynchronous messaging system, the first data being received in the second computing system in a first asynchronous message;
receiving, in the second computing system, a second asynchronous message altering the first data, wherein the altering of the first data was performed in the first computing system after a selected time before a predefined event of the transaction is to occur, the predefined event being dependent on the first data;
determining whether or not the predefined event has occurred, and if so, rejecting the altered first data, and if not, accepting the altered first data.

16. The computer-implemented method of claim 15, wherein the transaction is a sales order transaction.

17. The computer-implemented method of claim 16, wherein the first computing system includes a sales order generating module, and wherein the first data is sales order information that is included in an electronic document that is transmitted in the first asynchronous message.

18. The computer-implemented method of claim 17, wherein the second computing system includes a sales order logistics application module that produces a delivery order for a sales order transaction.

19. The computer-implemented method of claim 15, wherein if the altered first data is rejected, sending from the second computing system and to the first computing system an asynchronous message that indicates the altered data has been rejected.

20. The computer-implemented method of claim 19, wherein upon receipt in the first system of the asynchronous message that indicates the altered data has been rejected, allowing reversal of the alterations to the first data in the first computing system.
